(19) United States
(12) Patent Application Publication
(10) Pub. No.: US 2025/0093536 A1
(43) Pub. Date: Mar. 20, 2025

(54) LOCAL RADIATION IMAGING VIA THREE-DIMENSIONAL (3D) CADMIUM-ZINC-TELLURIDE (CZT) SYSTEMS WITH APERTURE MASKS

(71) Applicant: M3D, Inc., Ann Arbor, MI (US)

(72) Inventors: Steven Brown, St. Augustine, FL (US); Jerimy Polf, St. Augustine, FL (US); Willy Kaye, Ann Arbor, MI (US)

(21) Appl. No.: 18/891,478

(22) Filed: Sep. 20, 2024

Related U.S. Application Data
(60) Provisional application No. 63/583,909, filed on Sep. 20, 2023.
(60) Provisional application No. 63/583,957, filed on Sep. 20, 2023.

(51) Int. Cl. G01T 1/29; G01T 1/24

(52) U.S. Cl. CPC G01T 1/2985; G01T 1/241; G01T 1/244; G01T 1/2992

(57) ABSTRACT

Mobile three-dimensional (3D) cadmium-zinc-telluride (CZT) radiation imager with aperture masks provide improved imaging speed and visual depth imaging capabilities, making the disclosed solutions suitable at least for intraoperative medical applications. A 3D CZT imager includes a plurality of CZT crystals configured to generate charge in response to incident radiation emitted from a radiated area within a portion of the anatomical body and one or more electrodes configured to collect the charge generated from the incident radiation and induce electrical signals in response to the collected charge. The 3D CZT imager further includes an aperture mask positioned between the plurality of CZT crystals and the radiation source/target being imaged. The mask includes openings being designed or configured for particular projections of a radiation distribution onto the plurality of CZT crystals. Solutions disclosed herein can generate localized 3D radiation image reconstructions in real-time or near real-time.

### CROSS-REFERENCE TO RELATED APPLICATIONS

This application claims priority to U.S. Provisional Application No. 63/583,909, titled “THREE-DIMENSIONAL (3D) CADMIUM-ZINC-TELLURIDE (CZT) RADIATION DETECTION” and filed on Sep. 20, 2023, and U.S. Provisional Application No. 63/583,957, titled “TECHNIQUES FOR ENHANCING INTRA-OPERATIVE THREE-DIMENSIONAL (3D) RADIOTRACER DETECTION IN SENTINEL LYMPH NODES” and filed on Sep. 20, 2023. The contents of each of the aforementioned applications are incorporated herein by reference in their entireties.

### BACKGROUND

Gamma rays are a form of electromagnetic radiation that is detectable through various devices, such as a semiconductor detector. Gamma rays can interact with the semiconductor detector, resulting in the generation of charge carriers through electron ionization. Negative charge carriers, such as electrons, can travel toward and be collected by an anode (a positively biased electrode), while positive charge carriers, such as holes in the semiconductor detector, can travel toward and be collected by a cathode (a negatively biased electrode). The absorbed charge carriers can induce a signal in the electrodes, which can be measured to determine the amount of charge absorbed. Given that the charge carriers derive from interactions of the gamma rays with the semiconductor device, the induced signals in the electrodes can be used to measure the incident gamma rays at the semiconductor device.

In medical settings, radioactive tracers can be injected into a target to enable radiation-based imaging of physiological functions and internal anatomical structures. Existing systems for detecting radioactive emissions in medical settings, such as Geiger counter pens, have several drawbacks. These existing systems lack visual guidance; for example, the Geiger counter pen simply provides auditory ticks when positioned close to radiation sources. These existing systems also do not measure nor communicate the depth of radiation sources below the surface of the target. Further, existing systems cannot discriminate or differentiate multiple radiation sources in a vicinity. For example, if a radiation-emitting lymph node is close to a radiation-emitting tumor, there is no way for the Geiger counter pen to indicate both the lymph node and the tumor in the vicinity. Finally, other existing systems for radiation-based medical imaging such as single-photon emission computed tomography (SPECT) machines are large machines that can take up an entire room and require long amounts of time (e.g., 30-45 minutes) to generate an image.

### BRIEF DESCRIPTION OF THE DRAWINGS

FIG. 1 illustrates a schematic view of an example mobile 3D CZT radiation imaging system, in accordance with embodiments of the present technology.

FIGS. 2A-2B depict examples of radiation imaging via a mobile 3D CZT radiation imaging system, in accordance with embodiments of the present technology.

FIG. 3 depicts an example mobile 3D CZT radiation imaging system configured with multiple detectors, in accordance with embodiments of the present technology.

FIGS. 4A-4B is a block diagram depicting example aperture masks for mobile 3D CZT radiation imaging systems, in accordance with embodiments of the present technology.

FIGS. 5A-1, 5A-2, and 5A-3 illustrate examples of radiation imaging via a mobile 3D CZT radiation imaging system configured with aperture masks, in accordance with embodiments of the present technology.

FIG. 5B depicts an optimization process for aperture masks for a mobile 3D CZT radiation imaging system, in accordance with embodiments of the present technology.

FIGS. 6A-6D illustrates schematic views of various aperture masks for a mobile 3D CZT radiation imager, in accordance with embodiments of the present technology.

FIG. 7 is a diagram that illustrates an example injection and uptake of radiotracers by sentinel lymph nodes.

FIG. 8 is a diagram that illustrates the injection site problem.

FIG. 9 is a flow diagram that illustrates example operations for improving three-dimensional radiation imaging in a localized region with multiple radiation sources, such as a region of interest with a radiotracer injection site and irradiated sentinel lymph nodes.

FIG. 10 is a block diagram that illustrates an example computer system configured to implement the technical solutions disclosed herein.

### DETAILED DESCRIPTION

The present disclosure provides solutions for real-time or near-real-time radiation imaging, suitable for intraoperative medical uses. In some examples, the disclosed solutions are configured to quickly generate high-resolution images with three-dimensional depth information in under one minute. As such, a surgeon can use the disclosed solutions for real-time visual guidance regarding where cancerous lymph nodes may be located within an anatomical body, for example.

The example headings for the various sections below are used to facilitate the understanding of the disclosed subject matter and do not limit the scope of the claimed subject matter in any way. Accordingly, one or more features of one example section can be combined with one or more features of another example section.

### I. Example Embodiments for Mobile 3D CZT Detectors

Radiation is used in medical applications to illuminate anatomic systems. In one application, radiation can be injected into a cancerous tumor to enable the radiation to drain through attached lymph nodes. Gamma rays can be emitted from the radiated areas and detected using a detection device (e.g., a semiconductor device, such as a cadmium-zinc-telluride (CdZnTe or CZT) detector), resulting in the radiated areas being illuminated in the image of the body. As a result, the image can be used to identify lymph nodes that are connected to and likely infected by the cancerous tumor to enable the removal of the infected lymph nodes.

Often, radiation imaging is performed using two-dimensional (2D) position-sensitive semiconductor detectors. For example, a semiconductor detector can be pixelated to enable the gamma rays incident upon different x-y locations of the semiconductor detector to be detected through the measurement of charge carriers created from the gamma rays and collected at the pixelated electrodes. One challenge associated with 2D position sensitivity is that the radiation measurement can be sensitive to parallax. That is, because gamma rays are emitted radially from radiated areas, gamma rays originating from a particular x-y location within the body can be incident upon multiple x-y locations within the semiconductor detectors, often creating unacceptable uncertainty in medical applications. When the thickness of the semiconductor detectors is increased or the detectors are placed closer to the imaged area, the number of x-y locations within the detector upon which a single gamma ray can be incident increases, resulting in a corresponding increase in uncertainty of the x-y location of the radiated area within the body.

To address these challenges, some semiconductor detectors can be placed far from the imaged area (e.g., between 30 to 60 centimeters (cm)) behind a collimator that filters gamma rays that are not normal or near normal to the semiconductor detector (e.g., an angle of incidence less than 0.1 degrees, 0.5 degrees, 1 degree, or 5 degrees). Thus, the detected gamma rays can be traced to a single x-y location in the body with lesser uncertainty. Given that a large number of the gamma rays are filtered out and that the gamma rays must travel a larger distance before detection, it can take long periods of time (e.g., between 30 to 45 minutes) to detect sufficient radiation to generate the image, thus rendering this technique unfavorable for some application where time is paramount, such as intrasurgical imaging. Moreover, the 2D position sensitivity of these detectors makes them useless for providing information in the z-dimension, which can be useful for identifying the location of radiated areas (e.g., infected lymph nodes) within the imaged area.

3D position-sensitive detectors provide the ability to overcome some of the disadvantages of 2D position-sensitive detectors and address concerns related to parallax. 3D position-sensitive detectors measure charge drift from the point at which the charge carriers originate within the semiconductor detector to the point at which they are absorbed by the electrodes. By analyzing the multiple detections of a single gamma ray at different x-y-z positions within the semiconductor detector, the angle of incidence at which a gamma ray is incident upon the semiconductor detector can be determined, which in turn can be used to determine the location of a radiated area from which the gamma ray is emitted. Further details about the use of 3D position-sensitive detectors can be found in U.S. Pat. No. 7,411,197 to He et al. and U.S. Patent Publication No. 2009/0114829A1 to He et al.

In particular, a 3D position-sensitive detectors according to the disclosed implementations include electrodes distributed about the CZT crystals of the detectors. For 3D CZT detectors, each anode pixel is associated with a column of space inside the detector volume. That is, the electrodes are associated with columns within the crystal defined/pixelated in 2D. The amplitude and/or timing of the induced signals on each anode is associated with a particular depth or Z position within the respective column. Thus, in contrast to anodes being associated with voxels defined throughout a crystal, anodes are associated with columns and the induced signals encode the depth or three-dimensional information within the pixelated columns.

Given that 3D position detectors trace the detections of gamma rays through the different points in the detectors, detecting radiation using 3D detectors can require complex calculations. In some cases, this complex detection of radiation from multiple sources and angles can make it difficult to reflect equally radiated sources with equal intensity, resulting in blurred or unprecise images. Moreover, the complexity of these calculations can increase detection speed, which can make some 3D detectors suboptimal for time sensitive applications, such as intrasurgical imaging. This complexity only increases when full body imaging is performed due to the increased number of detections and the larger distances between the radiated areas and the detector. In some applications, however, it may only be necessary to image a small target area. For example, a surgeon may wish to image a tumor and its surrounding area to determine the location of affected lymph nodes through which radiation from the tumor is drained. Accordingly, there is a need for a 3D position-sensitive radiation imager capable of providing a timely image of a target area.

The present technology provides such systems and techniques. Specifically, a 3D CZT radiation imager is disclosed. The 3D CZT radiation imager includes a compact semiconductor detector (e.g., 5 cm×5 cm×10 cm) capable of providing a fast (e.g., less than one minute), accurate, and low-cost image of the target area. Given its compact size, the semiconductor detector can be placed close (e.g., less than 20, 18, 15, 12, 10, 8, 5 cm, and so on) to the body to specifically image a smaller target area (e.g., within the footprint of the detector). The 3D CZT radiation imager can have a larger thickness (e.g., greater than 5, 6, 7, 8, 9, 10, 12, 15, 20 cm, and so on) than other semiconductor detectors to enable a greater number of gamma rays to be detected. As a result, the radiation image can be generated more quickly in comparison to other semiconductor detectors.

At least due to the proximity of the imager to the target region and its 3D sensitive capabilities, a 3D radiation image can be obtained from the imager independently. This contrasts with computed tomography systems in which attenuation signals from multiple different positions and angles around a slice need to be collected in order to reconstruct an image of the slice. Notwithstanding, the compactness and mobility (e.g., handheld or attached to a mobile platform to allow the imager to placed in proximity to a target region) of the imager provides modularity; multiple of the imager systems disclosed herein can be used intra-operatively to image the same target region, with each of the multiple imager systems independently generating a radiation image. In such implementations, the radiation images generated or reconstructed from each imager can be combined, averaged, aggregated, or the like to confirm depth values, reduce signal noise, and/or the like.

According to embodiments disclosed herein, a mask of radiation blocking material (e.g., tungsten) can be placed over and around the semiconductor detector(s) to control the locations and angles at which gamma rays can be incident upon the semiconductor detector. Specifically, openings can be located in select locations to enable gamma rays to pass from radiated areas to the semiconductor detectors. The openings can be located to ensure appropriate calibration of the semiconductor detectors such that equally radiated areas appear with equal intensity in the radiation image. In aspects, different mask designs are discussed that include the use of pinhole openings and annular openings. The openings can be designed with particular taper patterns to enable gamma rays from specific locations and angles to be detected. The location and taper patterns of the openings can be considered when determining the location from which a detected gamma ray was emitted. For example, the back tracing of multiple detections of the gamma ray to a particular location from which it was emitted can be limited to locations from which the gamma ray could pass through the openings, given their location and taper patterns, and be incident upon the semiconductor detector at the locations at which the detections occurred.

Thus, the aperture masks disclosed herein particularly improve the 3D imaging of radiation, based on being implemented with 3D CZT radiation images having multiple thick semiconductor detectors. The characteristic image blurring seen with standard 2D imagers can be eliminated by using aperture masks with the 3D imager systems disclosed herein, which not only detect the lateral position (x, y) of gamma interactions, but also the depth (z) of interaction in the 3D gamma detectors.

This blurring is caused by gammas incident on the mask at oblique angles, resulting in the gamma being traced to the wrong location, reducing the achievable spatial resolution of the imagers. Using depth of interaction data to remove this blurring allows our imager to produce sharper images and achieve high spatial resolution. For standard 2D imagers, this blurring can only be reduced by using a thin detector and/or a collimator to restrict the field of view. This reduces detection sensitivity, resulting in longer image acquisition times compared to a thick (and 3D-sensitive) detector that uses the disclosed aperture masks with a large acceptance angle. For example, some aperture masks disclosed herein include many pinholes arranged in a predefined pattern, offering higher detection sensitivity (˜10×-100×) than a single pinhole.

In some embodiments, coded aperture masks may have a low dynamic range of image intensities due to the gammas emitted from separate sources (i.e., separate lymph nodes and lesions) passing through respective pinhole openings in the mask and interacting in the same detector pixels. In essence, gammas from multiple sources contribute to the signal, known as “multiplexing.” This feature of coded aperture imaging tends to boost the image signal-to-noise ratio (SNR) for the most intense sources in the image but degrade SNR for the relatively weak sources, thereby limiting dynamic range. In some embodiments, coded-aperture-based SLN mapping has a dynamic intensity range of their conventional mask was only 5-10. However, nodes near the radiotracer injection site can have intensities of only 1-2% of that of the injection site, requiring a dynamic intensity range of 50-100 to make them visible. Some embodiments of aperture masks disclosed herein address these challenges by including non-pinhole openings, such a slit openings or ring openings. Various embodiments of aperture masks disclosed herein may be selected depending upon the application and the known characteristics of a target region being imaged, such as whether there are multiple lymph nodes expected.

Finally, disclosed solutions with high-resolution and efficient masks paired with 3D-position sensitive gamma detectors allow systems to produce a complete 3D image from a single imager at a single location, thus improving upon existing standard systems in which multiple imagers at multiple locations are needed to produce a 3D image. Various embodiments of aperture masks can further speed up 3D image acquisition by allowing the use of a 3D “convolution” image reconstruction technique, which has the potential to speed up image reconstruction by a factor of 100× or more compared to the commonly used 3D image reconstruction algorithms.

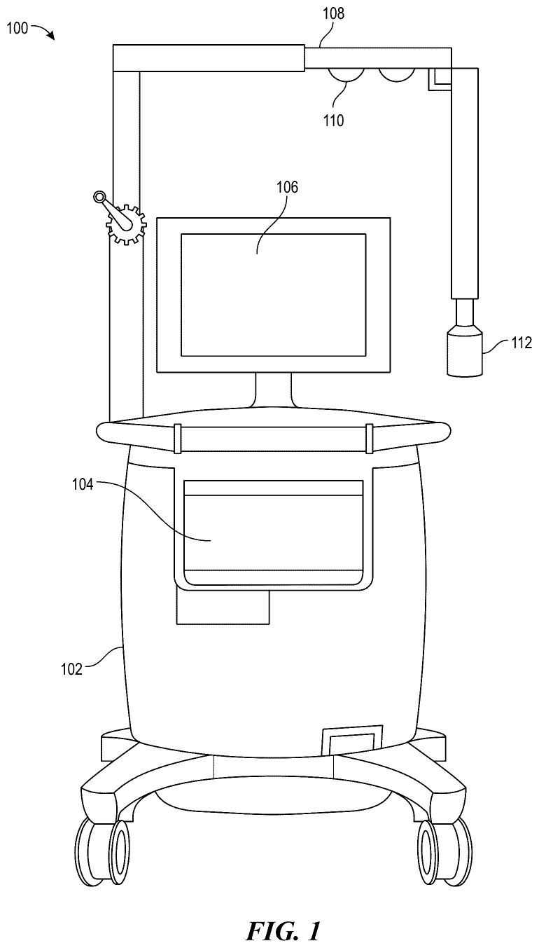

FIG. 1 illustrates a simplified schematic view of a 3D CZT radiation detection system 100 in accordance with an embodiment of the present technology. The 3D CZT radiation detection system 100 includes a base 102, at least one processor 104, a display 106, an arm 108, at least one camera 110, and a CZT detector 112. The base 102 can house the at least one processor 104 and support the display 106 and the arm 108. The base 102 can be portable such that it can be easily moved in and out of surgical rooms. For example, the base 102 can include wheels to allow the base to be rolled on the floor. Although not illustrated, the base 102 can house or support one or more additional input/output devices, such as a keyboard, mouse, controller, printer, or other device.

The at least one processor 104 can include any number of processors that perform computations to enable any of the functionality of the 3D CZT radiation detection system 100. For example, the at least one processor 104 can include any one or more of a central processing unit (CPU), graphical processing unit (GPU), a System-on-Chip (SoC), an application-specific integrated circuit (ASIC), and so on. In some cases, the 3D CZT radiation detection system 100 can include an ASIC capable of performing the detections of incident gamma rays at the CZT detector 112 and at least one separate processor 104 capable of generating a radiation image from the detected radiation or providing functionality to the display 106.

The display 106 can be supported by the base 102. For example, the display 106 can be housed within the base 102 or be attached to a stand that is connected to or supported by the base 102. The display 106 can include any number of displays, such as a liquid crystal display (LCD), a light-emitting diode (LED) display, or an organic LED (OLED) display. The display 106 can present an image of the patient provided by the camera 110, a radiation image provided by the CZT detector 112, or a combined image of the image from the camera 110 and the radiation image from the CZT detector 112.

The arm 108 can attach to the base 102 and support the camera 110 or the CZT detector 112. The arm 108 can be functionally coupled to actuators to position the arm 108 such that the camera 110 or the CZT detector 112 is in a particular configuration for radiation imaging. The arm 108 can be positioned into a variety of configurations to enable local imaging at different locations on differently sized patients.

The camera 110 can be disposed at the arm 108 to enable imaging of the patient. For example, the camera 110 can provide an image of the patient that can be overlayed with the radiation image to provide greater detail about the specific location of a radiated area within the patient. Although illustrated at a different portion of the arm 108 from the CZT detector 112, the camera 110 can instead be located at a same portion of the arm 108 as the CZT detector 112.

The CZT detector 112 can similarly be disposed at the arm 108. As illustrated, the CZT detector 112 is located at the distal portion of the arm 108 to enable positioning the CZT detector 112 close to a target area. The CZT detector 112 can be relatively small (e.g., 5 cm×5 cm×10 cm) to enable the CZT detector 112 to detect radiation within a small target area. The CZT detector 112 can be pixelated in the z-dimension to enable the detection of gamma rays at a particular x-y-z location. The CZT detector 112 can include CZT material and one or more biased electrodes (e.g., anode and cathode). In aspects, the CZT material in the CZT detector 112 can be thicker than in other CZT detectors (e.g., greater than or equal to 10 millimeters) to enable a greater number of gamma ray detections. The CZT detector 112 can further include circuitry to provide functionality to the CZT detector. For example, the CZT detector can include circuitry connecting to the biased electrodes to measure electrical properties at the electrode. Alternatively or additionally, the circuitry (e.g., an ASIC) can perform one or more operations to trace multiple detections of a gamma ray to a single source.

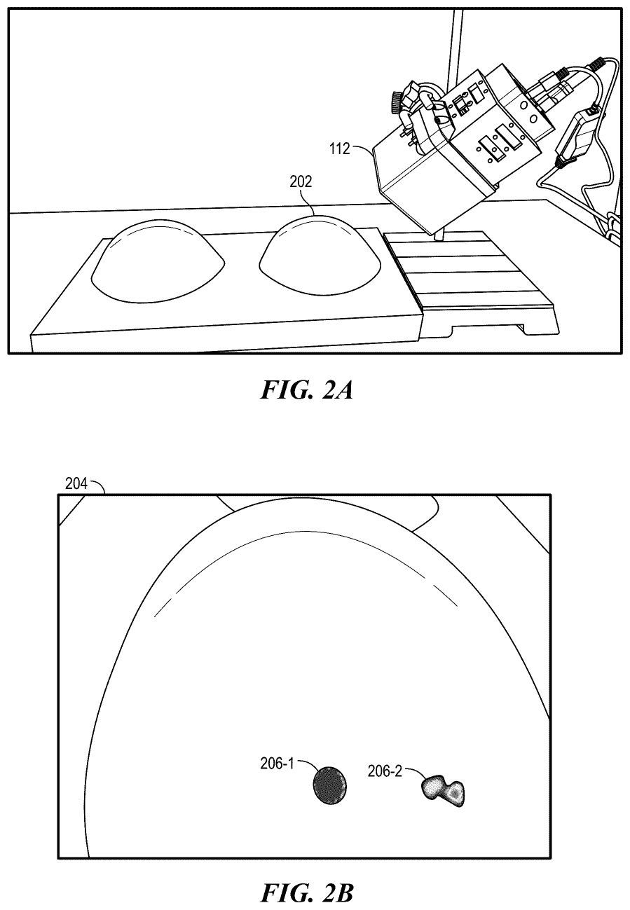

FIG. 2 illustrates a simplified schematic view of a 3D CZT detector 112 in operation in accordance with an embodiment of the present technology. As illustrated, the CZT detector 112 is used to image a target area 202 (e.g., phantom breasts). The CZT detector 112 is placed in close proximity to the target area 202 such that a local radiation image 204 of the target area 202 can be created. In aspects, the configuration and position of the CZT detector 112 can enable generation of the local radiation image 204 in less than one minute.

The local radiation image 204 can include one or more radiated areas 206 (e.g., radiated area 206-1 and radiated area 206-2). The radiated areas 206 can be presented with a particular color to indicate an amount of radiation detected. For example, the radiated area 206-1 can appear red to indicate a greater amount of radiation than detected at the radiated area 206-2, which appears blue. Moreover, different portions within the same radiated area can appear with different severity. As illustrated, a lesser-radiated portion of the radiated area 206-2 appears blue, and a greater-radiated portion of the radiated area 206-2 appears red. In some embodiments, the local radiation image 204 can be overlayed with an image from a camera (e.g., camera 110 described in FIG. 1). For example, the local radiation image 204 includes radiated areas 206 overlayed on a camera image of the target area 202.

In some embodiments, the radiated areas 206 are tagged, labelled, flagged, and/or the like with indicators in the local radiation image 204, a camera image, and/or a combination/overlay of the local radiation image 204 and the camera image. The indicators that correspond to the radiated areas 206 in the images include numerical values that indicate a (three-dimensional) depth of the radiated areas 206, and these depth values may be determined according to the techniques and aspects of the technology discussed herein. As one non-illustrative example, radiated area 206-1 may be labelled in the image shown in FIG. 2 with an indicator (e.g., a visual label, box, flag, or the like that is overlaid the image) of “5 mm deep” and radiated area 206-2 may be labelled with an indicator of “3 mm deep.” In some embodiments, a 3D CZT radiation detection system is configured to, as an alternative to using color grading to indicate relative radiation intensity, use color grading to indicate depth. In some embodiments, a 3D CZT radiation detection system is configured to enable dynamic toggling between relative radiation intensity being indicated by colors in the image and three-dimensional depth being indicated by the colors in the image.

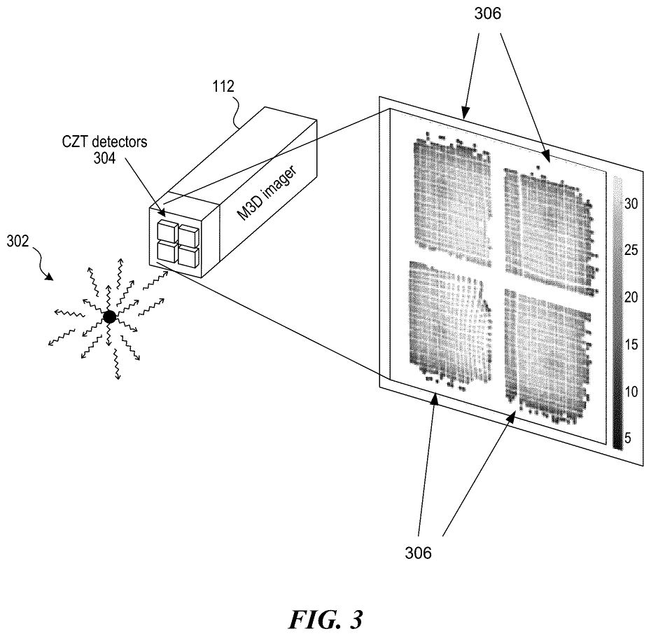

FIG. 3 illustrates an example of a mobile 3D CZT radiation imaging system configured with multiple detectors. The mobile 3D CZT radiation imaging system includes an imager (e.g., CZT detector 112 of the system 100). The imager may be mobile based on having a compact and limited size; for example, the imager can be handheld. As illustrated, the imager includes a plurality of CZT crystals 304. In the illustrated example, the imager includes four crystals that are arranged in a 2×2 array. Each crystal may have a square profile. The CZT crystals 304 may be arranged so that their front surfaces are aligned or co-planar. Each CZT crystal 304 individually and independently generates charge in response to incident radiation emitted from a radiation source 302. Thus, a radiation emission distribution 306 corresponding to each CZT crystal 304 can be generated or reconstructed. An overall radiation image can be generated from the radiation emission distributions 306 corresponding to the plurality of CZT crystals 304. For example, each CZT crystal acts as its own independent detector and views the radiation emission distribution through a respective or corresponding opening in an aperture mask, as disclosed further below.

In some embodiments, the CZT crystals 304 are thicker than those in existing systems, allowing for faster and more accurate computation of radiation emission depth. The increased thickness allows for more charge drift and tracking of radiation emissions. In some embodiments, the CZT crystals 304 have a thickness depth greater than or equal to 10 mm, 12 mm, 15 mm, or 20 mm. The increased thickness of the CZT crystals is accounted for by the limited number of crystals in the handheld system. For example, a whole-body radiation imaging system (such as computed tomography systems) may include a high number of crystals, which are kept thin due to resource constraints. In contrast, the imaging systems disclosed herein may have a limited number of crystals (e.g., four crystals, six crystals, nine crystals, sixteen crystals), and an increased thickness of the crystals is not prohibitive on overall system cost, size, or operation.

Reconstruction of a radiation image from the radiation emission distributions 306 sensed by the plurality of CZT crystals 304 can account for non-uniformity across the CZT crystals 304. For example, differences between the radiation source position in the radiation image and its true position in 3D space can be measured, using experimental point radiation sources set at known positions in the camera's field of view. The actual location of the gamma ray interaction in the CZT crystals can be distorted by natural impurities and material non-uniformity in the CZT, leading to the recorded gamma location to be incorrect. This distorts the final image reconstructed from the measured data. By measuring the systematic difference between expected vs actual counts distribution on the detector from sources throughout the field of view, a “calibration map” can be developed to be used to correct the counts distribution on the detector and obtain a more accurate map of the recorded gamma interactions, which in turn allow a more accurate reconstruction of the source position and intensity in the 3D radiation image.

Example embodiments may use an iterative “convolution” based maximum-likelihood expectation-maximization (MLEM) reconstruction method to speed up the 3D image reconstruction. In contrast to a standard MLEM that uses straightforward matrix multiplication during each iteration of the reconstruction, an example MLEM method in example implementations would use matrix convolution (e.g., utilizing Fast Fourier Transforms) when forming the statistical most likely estimation of the image. By making this change we can reduce the number of matrix multiplication operations in the reconstruction for an image that is M pixels×M pixels, from M⁴ for standard MLEM, to M²*log₂²(M) for the Convolution MLEM method. As an example, for an image size of 512 pixels×512 pixels, MLEM would require 7E10 multiplication operations per iteration of the reconstruction, whereas the convolution method would only require 2E7 (a factor 3,000× fewer). Thus, example implementations can enjoy a ˜1,000× reduction in reconstruction time, meaning the images can be reconstructed in <5 seconds.

### II. Example Embodiments for 3D CZT Detector Masks

Because of their offset positions, each of the four CZT crystals or detectors within an imager views the source from slightly different perspectives. Much like a stereo camera, it is possible to use this parallax to tell source depth. That is, 3D imaging can be enabled or enhanced by the parallax between the multiple CZT crystals in the imager. It is generally not feasible to resolve a one source occluded by another, but it is possible to resolve the depth of sources separated laterally in the image. Hence, a depth map can be reconstructed.

The reconstruction of a depth image can be done by first reconstructing a 3D volumetric image in the space in front of the mask, then finding the maximum intensity pixel and its corresponding depth along each column of pixels. The result is a 2D radiation image and depth map. Alternatively, it is possible to avoid performing the fully 3D image reconstruction by directly solving for the intensity and depth of each pixel in 2D. This can help speed up the reconstruction and constrain the result to obtain better results.

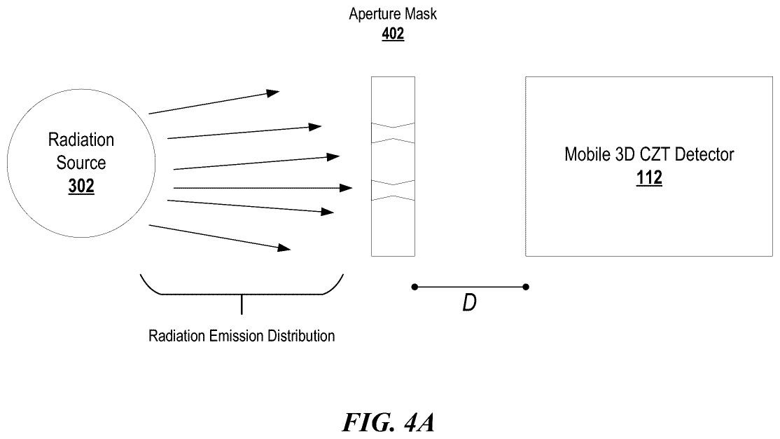

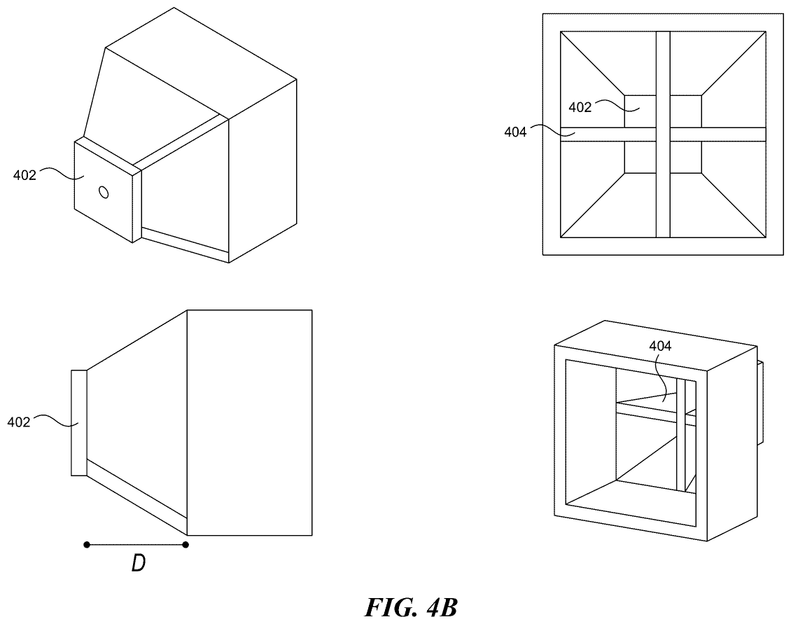

FIG. 4A illustrates an example of a 3D CZT radiation imaging system including an aperture mask 402. The aperture mask 402 is positioned in front of the imager (e.g., the CZT detector 112 in the system 100), such that the aperture mask 402 is positioned between the imager and a radiation source 302 that is the target of the imaging. Accordingly, radiation energy emitted by the radiation source is incident upon the aperture mask 402 prior to reaching the imager (or instead of reaching the imager). As explained in further detail below, an aperture mask 402 includes openings that are configured to project the radiation emission distribution onto the imager, in a manner that enhances image reconstruction and 3D depth sensing.

As further illustrated in FIG. 4A, the aperture mask 402 can be positioned at a distance D in front of the imager. The distance D may be based at least in part on the configuration/dimensions of the openings in the aperture mask 402, such that the aperture mask 402 is positioned to focus the projections onto the crystal detectors of the imager. Because the imagers disclosed herein may be used for localized imaging and may be positioned close to a region of interest with low target field-of-view (FOV), the distance D may be less than that of existing imaging systems. For example, the distance D may be less than 50 mm, less than 40 mm, between 50 mm and 30 mm, or between 40 mm and 35 mm.

FIG. 4B illustrates an attachment of the aperture mask 402 to an imager. In particular, FIG. 4B illustrates that the aperture mask 402 can be fixed to the imager with a septum 404 being positioned between the aperture mask 402 and the imager (or the crystal detectors of the imager). The septum 404 can be cross-shaped and is generally configured to isolate the crystal detectors of the imager. In particular, the septum 404 may be cross-shaped for an imager with a 2×2 array of four crystal detectors; however, in other crystal detector arrangements/configurations, the septum 404 may have other shapes.

A cross-shaped septum can be used with the slit mask or four-pinhole aperture masks disclosed in further detail below to isolate the projections from each of the four openings. This prevents hot sources from one projection from obscuring weak ones in another. This feature can be important for imaging weak sources such as sentinel nodes near an injection site.

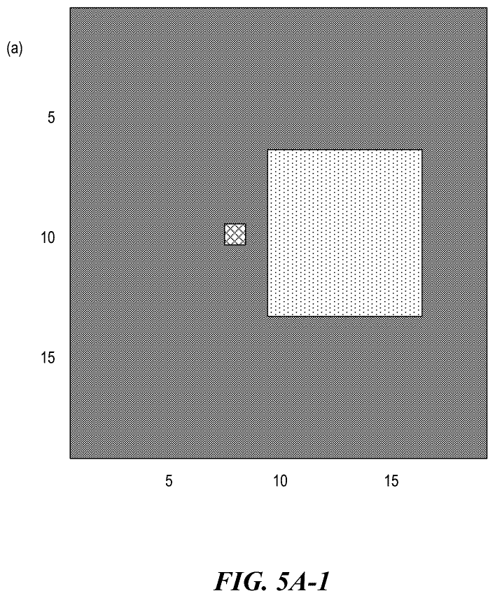

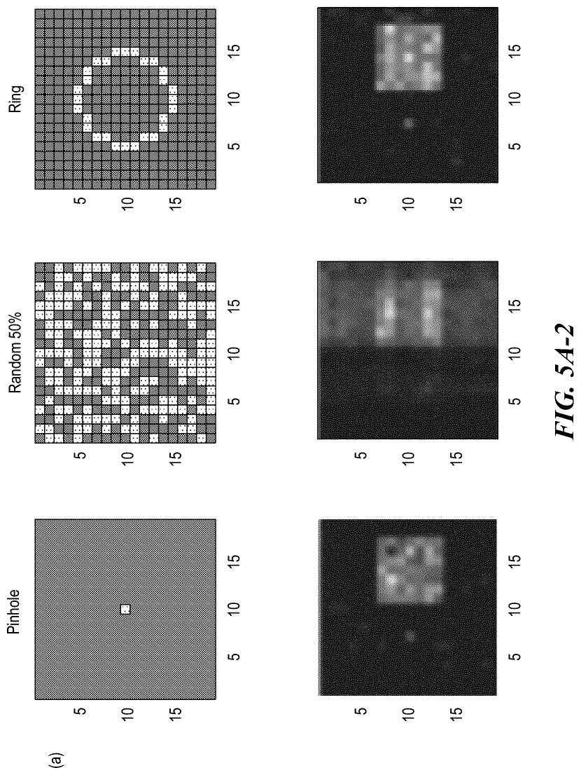

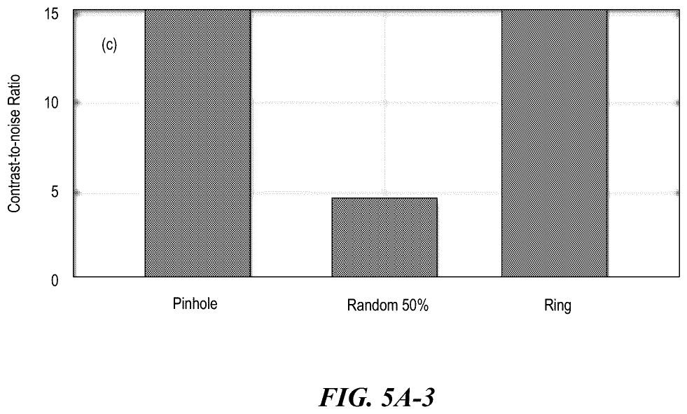

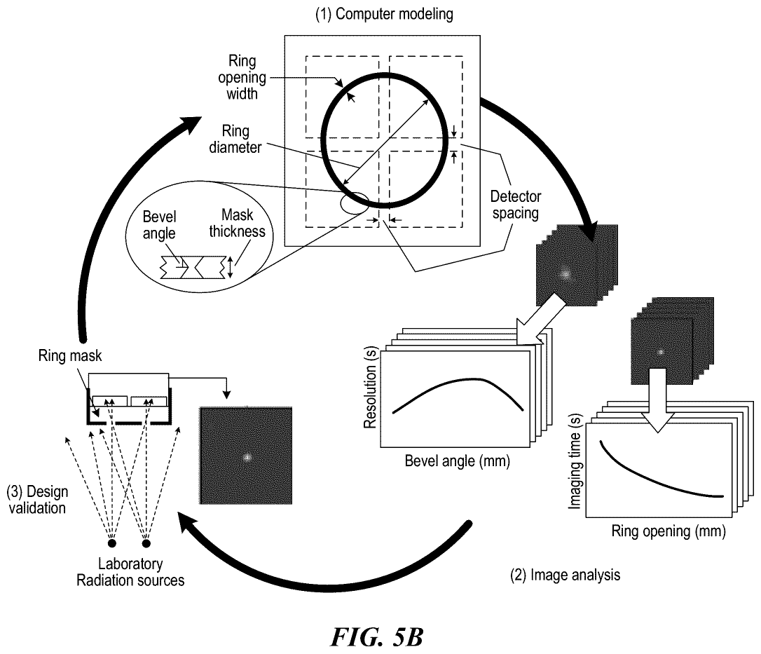

FIGS. 5A-1, 5A-2, and 5A-3 show example simulation data from mask designs. The simulation data shown is provided from an initial simulation study of three coded aperture mask designs: 1) a pinhole mask (a single open hole in the middle of mask), 2) a 50% open fraction mask (randomly chosen 50% percent of mask open), and 3) a ring mask (open ring), as depicted in the top row of FIG. 5A-2. The detection of gammas emitted from a source containing a “high activity injection site” and a small “weak activity lymph node” (1% of injection site activity) 2 cm away (as depicted in FIG. 5A-1) was simulated. From the images generated from the cameras containing these masks (depicted in the bottom row of FIG. 5A-2), it can be seen that the weak activity node can be seen in the pinhole and ring mask cameras. Plus, both the pinhole and ring mask images have a contrast-to-noise ratio (CNR) of >15, as shown in FIG. 5A-3, where CNR is defined as the ratio of the image signal of the weak node to the background noise in the image.

Typically a CNR >5 is needed to allow an object to be identifiable in an image 100% of the time. In this case, the node is easily identifiable for the pinhole ring masks, but not for the 50% random mask (CNR <5). The pinhole and ring masks were adequate for identifying a node next to the injection site, as needed for intraoperative SLN biopsy and resection procedures. However, the detection sensitivity of the ring mask (183 counts/second/MBq of 99mTc) was about 6× higher than the pinhole collimator (3 counts/second/MBq of 99mTc). This higher sensitivity allowed for 70% faster image acquisition with ˜2× higher CNR, for nodes away from the injection site, than that of the pinhole mask.

FIG. 5B depicts an optimization process for aperture masks for a mobile 3D CZT radiation imaging system. Various parameters of the masks disclosed herein can be adjusted and optimized based on testing and simulating with radiation sources. In particular, parameters for a ring mask, for example, can include ring opening width, ring diameter, bevel angle, mask thickness, and detector spacing. In some embodiments, the ring opening width is between 0.6 mm to 1 mm, between 0.4 mm to 2 mm, or between 0.2 mm to 2.5 mm. In some embodiments, the ring diameter is between 15 mm to 20 mm, 10 mm to 25 mm, and 10 mm to 30 mm. In some embodiments, the bevel angle is between 0 degrees to 30 degrees. In some embodiments, the mask thickness may be between 2 mm to 16 mm, between 5 mm to 14 mm, or between 7 mm to 10 mm. In some embodiments, the detector spacing may be between 5 mm to 20 mm, between 8 mm to 15 mm, or between 10 mm to 13 mm. These exemplary values can be adjusted based on the optimization or design process.

Furthermore, the arrangement or configuration of openings in the mask can be configured for different optimization goals. The ring mask is well suited because the circular opening has a large diameter, maximizing parallax. The four-pinholes are also suitable for 3D imaging because of their large separation distance. The slit mask is less favorable because they are asymmetric, and some slits are extended in the radial direction. These features can cause worse depth resolution.

The masks disclosed herein are configured to fit to one imager that includes multiple CZT crystals aligned within to each receive radiation emissions. Accordingly, the masks each include a plurality of openings that correspond to the multiple CZT crystals, so that each CZT crystal included in the imager “views” the radiation emissions (or a radiation emission distribution) through one or more of the openings in the mask. Furthermore, the masks disclosed herein are a single piece of radiation blocking material that is attached to a front end of the imager to which the CZT crystals are aligned. Thus, in some embodiments, the masks disclosed herein may be square, or have a shape corresponding to the front end of the imager. In some embodiments, the length and width of an example mask may be less than the length and width of the front end of the imager, as suggested in FIG. 4B.

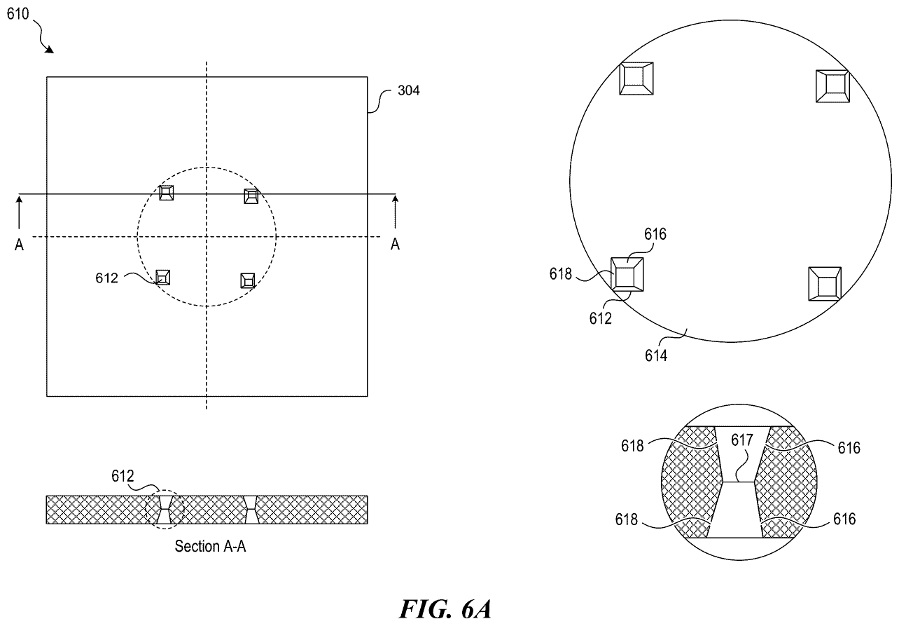

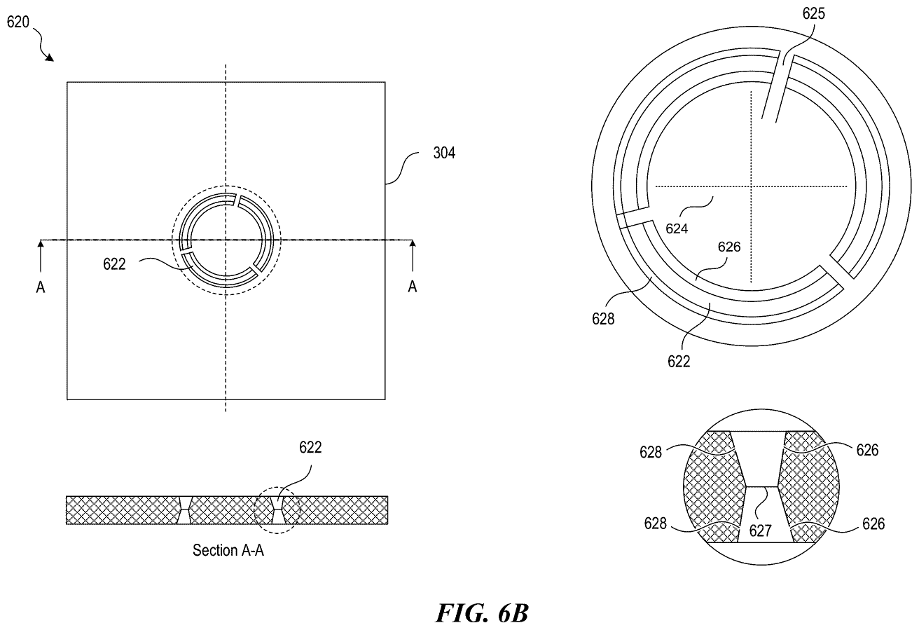

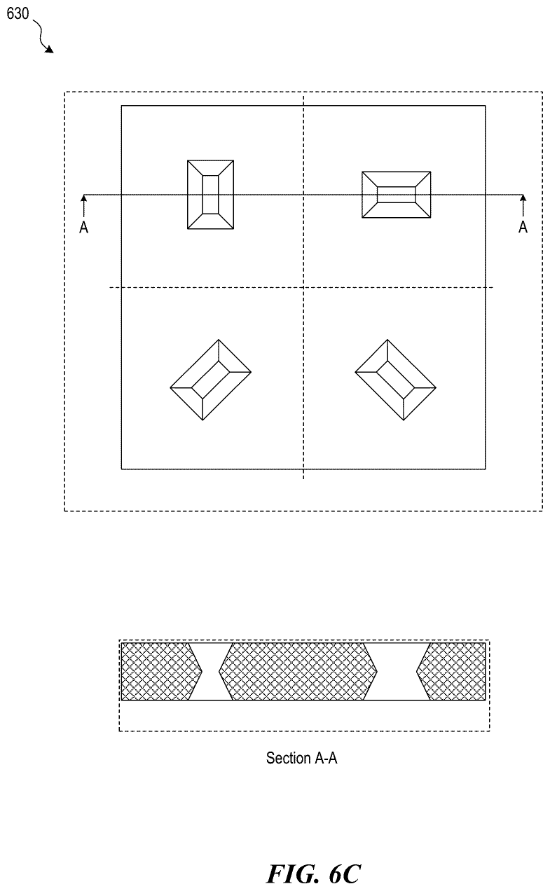

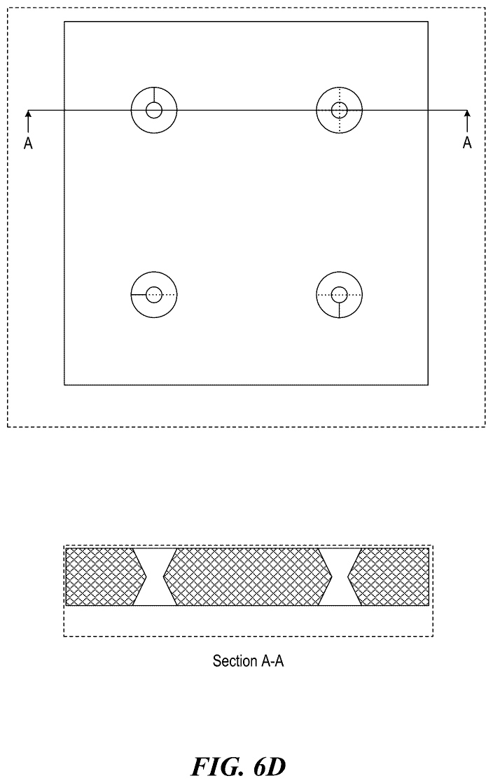

FIG. 6A illustrates schematic views of a mask 610 for a 3D CZT radiation imager in accordance with an embodiment of the present technology. Specifically, a top view of the mask 610 (top right) illustrates four pinhole openings 612 that extend through radiation blocking material 614 (e.g., tungsten). Although illustrated as four pinhole openings, the pinhole openings 612 can instead include greater or fewer openings. In some embodiments, the number of openings included in the mask corresponds to a number of semiconductor crystal detectors in the mobile 3D CZT radiation imager. The openings can be located within the mask at locations corresponding to the arrangement of semiconductor crystal detectors in the mobile 3D CZT radiation imager. For example, the openings align with, or are offset from, a center of a corresponding semiconductor crystal detector.

The pinhole openings 612 can be tapered such that cross sections of the openings 612 at different cross sections of the mask 610 (along planes parallel with the illustrated plane) are different sizes. The pinhole openings 612 can be tapered by different amounts at different portions. For example, inside edges 616 of the pinhole openings 612 that are closer to the center of the mask 610 can be tapered by a greater amount than outside edges 618 of the pinhole openings 612, or vice versa.

The cross section of the pinhole openings 612 can be shown in the side cross section view of the mask 610 (bottom left). For example, the pinhole openings 612 can be tapered toward an internal line 617 at an equal depth between the first side and second side of the pinhole openings 612. Thus, when moving from the first side to the second side, the pinhole openings 612 can shrink when moving toward the internal line 617 and expand when moving away from the internal line 617. Although illustrated as being in the middle of the pinhole openings 612, the internal line 617 can instead be closer to the first side or the second side. As discussed above, the pinhole openings 612 can be tapered by different amounts at different portions. Referring back to the previous example, the inside edges 616 of the pinhole openings 612 can be tapered by a greater amount than the outside edges 618. When the pinhole openings 612 are tapered toward an internal line 617, opposite edges on opposing sides of the internal line 617 can be tapered symmetrically. For example, outside edges 618 and inside edges 616 on the second side of the internal line 617 can be tapered the same as the inside edges 616 and the outside edges 618, respectively. Alternatively, opposing edges on opposing sides of the internal line 617 can be tapered asymmetrically.

Referring now to the top view of the mask 610 (top left), where the mask 610 is disposed over four semiconductor crystals 304 of a semiconductor detector (e.g., a CZT detector). As illustrated, the semiconductor crystals 304 are arranged in a grid, and the mask 610 is centered at a center point of the four semiconductor crystals 304. The mask 610 can be configured such that each of the pinhole openings 612 are within a footprint of a respective one of the four semiconductor crystals 304. In aspects, the pinhole openings 612 can be arranged such that each one of the pinhole openings 612 is spaced from a first side of the respective one of the four semiconductor crystals 304 by a first amount (e.g., 19.7 mm) and a second side of the respective one of the four semiconductor crystals 304 by a second amount (e.g., 20.4 mm).

Even though the semiconductor crystals 304 are implemented using four discrete crystals, the openings 612 can be positioned and tapered to enable radiation emitted from any region within the imaged portion of the body to be detected, including regions in line with the gaps between the semiconductor crystals 304. For example, the openings 612 can be located and tapered such that radiation emitted from a portion of the body that is directly aligned with the gaps between the semiconductor crystals 304 can be imaged through detections of radiation emitted in a diagonal direction incident on one or more of the semiconductor crystals 304. In doing so, a continuous image can be created from discontinuous semiconductor crystals 304. Similarly, the openings 612 can be selectively located and tapered to ensure that similar amounts of radiation emitted from different regions within the body are detected with similar magnitudes. Thus, the radiation can be detected such that propositional intensity is displayed throughout the image.

FIG. 6B illustrates schematic views of a mask 620 for a 3D CZT radiation imager in accordance with an embodiment of the present technology. Specifically, a top view of the mask 620 (top right) illustrates three discrete annular openings 622 that extend through radiation blocking material 624 (e.g., tungsten). Although illustrated as three openings, the openings 622 can instead include greater or fewer openings. Each of the discrete openings 622 can be separated by bridges 625 of the radiation blocking material 624. The bridges 625 can have similar or different dimensions. In aspects, the bridges 625 can make the radiation blocking material 624 self-sustaining such that an inner portion of the radiation blocking material 624 on the interior of the openings 622 (e.g., closer to the center of the mask 620) connects with an exterior portion of the radiation blocking material 624 on the exterior of the openings (e.g., further from the center of the mask 620). The openings 622 can be tapered such that cross sections of the openings 622 at different cross sections of the mask 620 (along planes parallel with the illustrated plane) are different sizes. The openings 622 can be tapered by different amounts at different portions. For example, inside edges 626 of the openings 622 that are closer to the center of the mask 620 can be tapered by a lesser amount than outside edges 628 of the openings 622, or vice versa.

The cross section of the openings 622 can be shown in the side cross section view of the mask 620 (bottom left). For example, the openings 622 can be tapered toward an internal line 627 at an equal depth between the first side and second side of the openings 622. Thus, when moving from the first side to the second side, the openings 622 can shrink when moving toward the internal line 627 and expand when moving away from the internal line 627. Although illustrated as being in the middle of the openings 622, the internal line 627 can instead be closer to the first side or the second side. As discussed above, the openings 622 can be tapered by different amounts at different portions. Referring back to the previous example, the inside edges 626 of the openings 622 can be tapered by a lesser amount than the outside edges 628. In some embodiments, the edges closer to a first side of the openings 622 (e.g., edges 626 and edges 628 above the internal line 627) can be tapered less than edges closer to the second side of the openings (e.g., edges 412 and 414 below the internal line 627), or vice versa. When the openings 622 are tapered toward an internal line 627, opposite edges on opposing sides of the internal line 627 can be tapered symmetrically or asymmetrically.

Referring now to the top view of the mask 620 (top left), where the mask 620 is disposed over four semiconductor crystals 304 of a semiconductor detector (e.g., a CZT detector). As illustrated, the semiconductor crystals 304 are arranged in a grid, and the mask 620 is centered at a center point of the four semiconductor crystals 304. The mask 620 can be configured such that each of the openings 622 is within a footprint of multiple of the four semiconductor crystals 304. In aspects, the openings 622 can be arranged along an annulus centered about the center point at which the four semiconductor crystals 304 meet.

Like the mask 610, the openings 622 of the mask 620 can be positioned and tapered to enable radiation emitted from any region within the imaged portion of the body to be detected, including regions in line with the gaps between the semiconductor crystals 304. For example, the openings 622 can be located and tapered such that radiation emitted from a portion of the body that is directly aligned with the gaps between the semiconductor crystals 304 can be imaged through detections of radiation emitted in a diagonal direction incident on one or more of the semiconductor crystals 304. In doing so, a continuous image can be created from discontinuous semiconductor crystals 304. Similarly, the openings 622 can be selectively placed and tapered to ensure that similar amounts of radiation emitted from different regions within the body are detected with similar magnitudes. Thus, the radiation can be detected such that propositional intensity is displayed throughout the image.

Another advantage of the mask 620 is that the openings 622 can allow a greater amount of radiation to pass through (e.g., approximately 10 times higher compared to a pinhole design) while selectively filtering gamma rays to simplify calculations that determine the location from which the detected gamma rays are emitted. In doing so, a greater amount of radiation can be detected at the semiconductor crystals 304, which allows the radiation image to be generated more expeditiously. Thus, the mask 620 can enable radiation imaging to be used in additional applications where speed is paramount, such as intraoperative or intrasurgical imaging.

In some cases, the annular mask 620 can be particularly beneficial for radiation imaging of the lymphatic system. For example, as discussed, the annular openings 622 can allow a greater amount of gamma rays to pass through the mask 620. In other imaging applications where radioactivity can spread in multitudes of ways throughout the body (e.g., to blood or adjacent organs), the large amounts of radiation from these adjacent locations that pass through the mask 620 can blur the image of targeted organs or areas. In lymphatic imaging, however, the diffusion of radiation can be restricted to the connected lymph nodes, which have a scattered connected structure. Thus, detected radiation from adjacent radiated areas can be limited in lymphatic imaging, and the disadvantages associated with an increased detection of gamma rays can be mitigated.

Thus, the ring-shaped mask has at least two main advantages over the pinhole. First, a ring-shaped opening will have an order of magnitude higher geometric sensitivity compared to a pinhole of the same geometric resolution. The counts from a single point source of radiation will appear in the shape of a ring projected onto the detector. By distributing the counts across multiple pixels along a ring, detector imperfections such as grid artifacts and dead pixels also tend to be averaged out. This is the second advantage of the ring over a pinhole. The disadvantage of the ring is that the projection of multiple sources tends to overlap on the detector. This can cause the projection from a hot source to overwhelm that of a weaker source, requiring more measurement time to resolve weak sources. For example, this can be a problem when trying to image a sentinel node next to an injection site.

FIG. 6C illustrates schematic views of a mask 630 for a 3D CZT radiation imager in accordance with an embodiment of the present technology. The mask 630 may be referred to as a slit mask, due to the openings 632 being slits instead of pinholes. The slits of the openings 632 may have different angles relative to each other. In the illustrated example, the mask 630 includes four slits at 45-degree angles relative to each other, which results in a point spread function that is shaped like an 8-point asterisk, with the most intense spot in the center. The four slits also have limited extent and so they can be recorded by each of the four CZTs individually, much like the four-pinhole design. This allows a septum to be placed between CZTs to limit the overlap between the projections from the different slits. Thus, the slit mask has similar advantages as the ring mask because it can have both high sensitivity and high resolution.

FIG. 6D illustrates schematic view of a mask 640 for a 3D CZT radiation imager in accordance with an embodiment of the present technology. The mask 640 includes pinholes in an aligned arrangement, in contrast to a staggered arrangement shown in FIG. 6A. Referring to FIG. 6A, there are four pinholes to project one image of the object onto each CZT. The pinholes are staggered so that each of the four projections are recorded by the detector at slightly offset positions in X and Y. This tends to mitigate artifacts introduced by detector pixelation and subpixel sensing. For example, if the counts are systematically biased towards the center or edges of each pixel, a regular grid will appear superimposed on the recorded projection. If all projections are sampled by the four CZTs in the same way, the artifact can be amplified when the images are aligned and summed. By staggering the pinholes, the projections are slightly offset so that the artifacts do not align and tend to average out when summed. Returning to FIG. 6D, the artifacts introduced by detector pixelation and subpixel sensing may be mitigated by increasing a size of the pinhole openings.

### III. Example Embodiments for Injection Site Filtering

The solutions disclosed herein that include mobile 3D CZT detectors with masks configured for real-time 3D radiation imaging are well-suited to support sentinel lymph node biopsy and other similar operations concentrated on a local region of a subject's body. Sentinel lymph node biopsy and these other operations introduce further technical challenges, which are also addressed by additional solutions discussed herein. Certain masks for a semiconductor detector can pass a greater amount of radiation compared to a pinhole mask, for example, in order to accelerate detection time or speed and enable real-time imaging; yet, doing so can undesirably capture other radiation sources besides a desired irradiated target. And by the nature of certain nuclear medicine applications, multiple radiation sources can be located in proximity of one another in a location region. For instance, radiation emitted from a nearby radiotracer injection site can be included in a captured signal, distracting from (and further interfering) the radiation emitted from sentinel lymph nodes. In some examples, radiation associated with a radiotracer injection site is 100 times hotter than radiation associated with sentinel lymph nodes, and precise identification of a sentinel lymph node becomes more challenging. Because of the focus on a small local area, these radiation sources are magnified (e.g., as point sources against a background with virtually no radioactive signal) and can interfere as noise with one another. As such, a need exists to improve radiation imaging in small local regions that may include multiple radiation sources, such as a local region with an injection site and a sentinel lymph node.

Techniques disclosed herein address at least these technical challenges. In an example, a technique that is implemented to improve intra-operative 3D radiation detection includes identifying an undesired or non-target radiation source (e.g., a radiotracer injection site) captured within a signal collected from a detector and having an intensity that is a threshold greater than a desired or target radiation source (e.g., one or more sentinel lymph nodes). The technique further includes filtering the signal to remove the non-target radiation source from the signal based on a mask configuration, the mask configuration being one that enables intra-operative 3D radiation detection. For example, the mask configuration includes an annular opening as described herein. The technique further includes generating a radiation image from the filtered signal and locating the target anatomical feature in a three-dimensional space using the generated radiation image. With certain mask configurations that are distinctively specific to improving or enabling intra-operative 3D radiation detection, signal components associated with undesired irradiated features can be identified more easily and then filtered. In some embodiments, additional operations relating to the identified non-target radiation source can be performed. For example, the 3D detector having a small or limited field-of-view (FOV) that is focused on the local region of the body can be re-positioned or re-oriented to place the identified non-target radiation source outside of the detector's FOV.

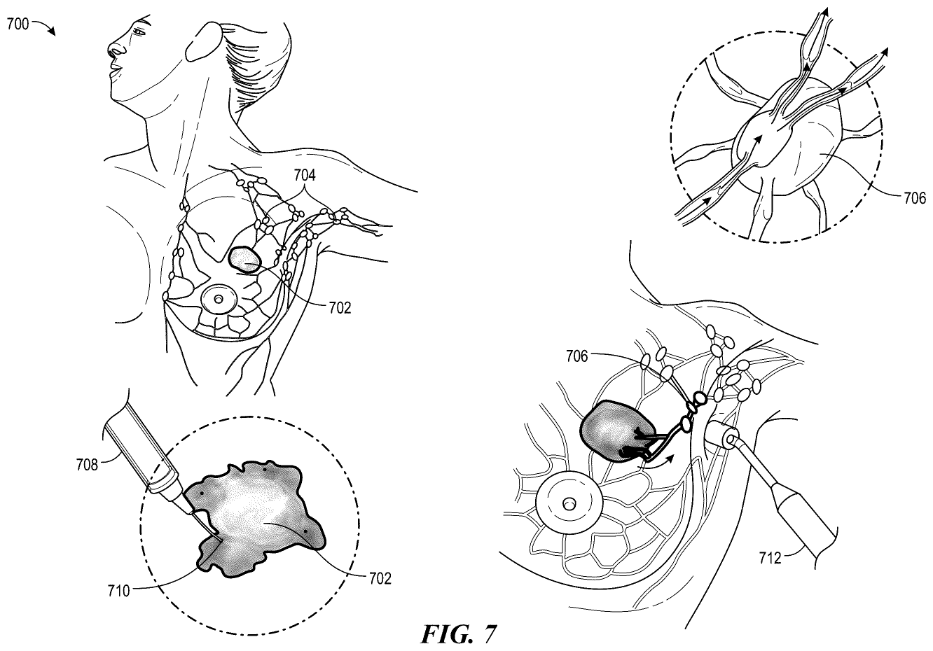

FIG. 7 is a diagram that demonstrates a use of radiotracers in medical applications with anatomical and/or physiological systems. The illustrated example specifically relates to sentinel lymph node detection, for example, for a sentinel lymph node biopsy. It will be appreciated however, that other similar medical applications involving radiotracers may be relevant to the present disclosure.

As illustrated, an anatomical body 700 may develop a tumor 702 that grows near a region or portion of the body's lymphatic network. This portion of the body's lymphatic network includes regional lymph nodes 704 that can be physiologically affected by the tumor 702, can spread the tumor 702 to other parts of the body 700, and/or the like. In particular, these regional lymph nodes 704 include sentinel lymph nodes 706 which represent the first lymph nodes affected by the tumor 702 (e.g., the first nodes to which the tumor 702 spreads). In order to manage and mitigate the spread of cancer, it is critical to identify these sentinel lymph nodes 706. Identification of these sentinel lymph nodes 706 allows surgical removal and biopsy of these sentinel lymph nodes 706, thereby limiting the means by which the tumor 702 is able to spread throughout the anatomical body 700.

Some existing medical imaging systems are limited in their ability to reliably and precisely identify sentinel lymph nodes 706. For one, lymph nodes are relatively small anatomical features, and existing systems configured for larger-scale full body imaging are not able to clearly resolve lymph nodes. Further, sentinel lymph nodes 706 are differentiated from other lymph nodes based on their physiological actions-namely lymphatic uptake or draining these lymph nodes. While some existing systems such as computed tomography are well-suited for imaging anatomical (e.g., structural) features, these systems struggle to specifically illuminate physiological features and characteristics of the anatomical features.

In order to detect sentinel lymph nodes 706, a radiotracer 708 can be injected into or near the tumor 702, at an injection site 710. The radiotracer 708 is a chemical compound (e.g., an organic substance) configured to emit radiation, for example, based on having components of the chemical compound replaced by a radioisotope or radioactively-decaying substance. From the injection site 710, the radiotracer 708 can spread as tumor cells of the tumor 702 would, for example, along the means provided by the lymphatic network of the body 700. As such, spread of the radiotracer 708 over time can simulate or represent a precursor of tumor cell spread. The radiotracer 708 spreads to sentinel lymph nodes 706 first, and detection of the radiation emitted by the radiotracer 708 can detect the sentinel lymph nodes 706.

According to example embodiments, a radiation detection or imaging system 712 is used to detect and track radiotracers 708 throughout the body. In particular, due to the small scale of lymph nodes (the region of interest need only include a few lymph nodes and optionally, the tumor 702 itself), the disclosed solutions for 3D CZT detection concentrated or focused on a small region is well-suited for embodying the radiation detection or imaging system 712. In contrast, various full-body and/or larger-scale imaging systems may fail to resolve lymph nodes and discriminate certain lymph nodes from others, as discussed above.

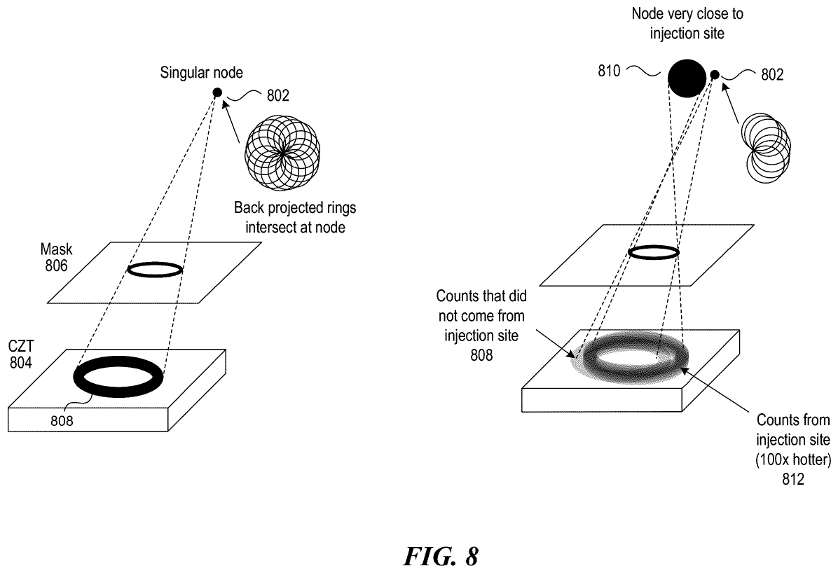

FIG. 8 is a diagram that demonstrates an example implementation of the 3D CZT radiation detection solutions disclosed herein for detecting sentinel lymph nodes. In particular, FIG. 8 demonstrates the technical challenge relating to overlapping or interfering point sources being detected when focusing on a small or local region of interest. In the left portion of FIG. 8, a nodal feature 802 can be imaged by an imaging system that includes a semiconductor detector 804 (e.g., a CZT semiconductor detector) and a mask 806 configured to accelerate or enable real-time radiation detection/imaging. For example, the mask 806 includes one or more annular openings that cause radiation emitted by the nodal feature 802 to project or cast shadows upon the semiconductor detector 804 in annular shapes, the shadows being radiation counts 808 or hits within a three-dimensional space of the semiconductor detector 804. The nodal feature 802 can then be identified and located (e.g., with respect to three dimensions) based on, for example, an intersection of the annular-shaped shadows of radiation counts 808 or hits.

In the right portion of FIG. 8, the nodal feature 802 is located in proximity to a non-target point source 810, such as a radiotracer injection site. In some examples, both the nodal feature 802 and the non-target point source 810 are point sources, or having a radiation intensity that is significantly greater than a surrounding area or background. The nodal feature 802 and the non-target point source 810 stand out as point sources against a low-signal background, for example due to the radiotracer being configured to concentrate in certain anatomical features (e.g., lymph nodes) and taking time to drain from the injection site. The nodal feature 802 and the non-target point source 810 have significantly greater radiation intensity than the background. In the illustrated example, the proximity of the non-target point source 810 to the nodal feature 802 interferes with the detection and identification of the nodal feature 802, due to shadows of non-target counts 812 being cast by the non-target point source 810 overlapping with the counts 808 originating from the nodal feature 802. As also demonstrated, the non-target point source 810 can emit a greater amount of radiation upon the semiconductor detector 804 relative to the nodal feature 802, in some examples.

In order to detect and identify the nodal feature 802, the non-target counts 812 within the three-dimensional space of the semiconductor detector 804 are excluded, such that a radiation image capturing the nodal feature 802 without the non-target point source 810 can be reconstructed. Although some of the radiation counts 808 originating from the nodal feature 802 may be eliminated with the exclusion and filtering of the non-target shadows 812, the nodal feature 802 can still be located due to the configuration of the mask 806, for example, with annular-shaped openings.

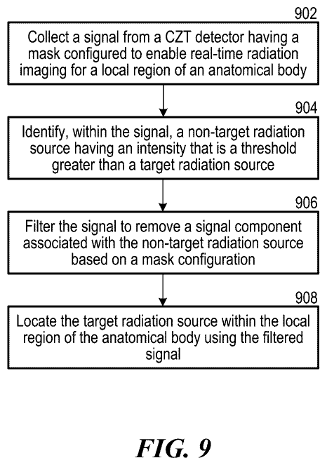

FIG. 9 is a flow diagram that illustrates example operations for improving three-dimensional radiation imaging in a localized region with multiple radiation sources, such as a region of interest with a radiotracer injection site and irradiated sentinel lymph nodes. In some embodiments, the example operations are implemented by a computer system; for example, the computer system includes at least one processor and at least one memory storing executable instructions that, when executed by the at least one processor, cause the computer system to perform the example operations. For example, the example operations are implemented by the 3D CZT radiation detection system 100 and its components, including the at least one processor 104.

At an operation 902, a system collects a signal from a radiation detection and/or imaging system for a local region of an anatomical body. In some embodiments, the radiation detection and/or imaging system is or comprises a three-dimensionally (3D) sensitive CZT detector and further comprises a mask configured to enable real-time radiation imaging. In some embodiments, the mask has an annular configuration, in which the mask includes annular openings. The signal collected by the system captures radiation intensity emitted from the local region of the anatomical body. In some embodiments, the system collects the signal during an operative procedure. For example, the signal is collected during (and is associated with) a time period subsequent to the injection of a radiotracer.

At an operation 904, the system identifies, via the signal, a non-target radiation source. The system can identify that the non-target radiation source is a feature different than a target radiation source. In some embodiments, the system determines that the intensity captured in the signal for the non-target radiation source is not consistent with an expected intensity that would be emitted by a target radiation source. For example, the system detects a radiation source (e.g., a radiotracer injection site) having an intensity that is approximately or at least 100 times greater than an expected intensity for a target radiation source (e.g., an irradiated sentinel lymph node). In some embodiments, the system compares an intensity of a feature captured by the signal to a threshold in order to identify the feature as a non-target radiation source. In some examples, the threshold can be anatomically-, physiologically-, and/or procedurally-specific. For instance, a threshold based on radiotracer injection sites having intensities that are approximately 100 times greater than an irradiated sentinel lymph node is specific to radiation imaging for a sentinel lymph node biopsy, and other thresholds can be established and used for other applications.

At an operation 906, the system filters the signal to remove a signal component associated with the non-target radiation source. The system can remove the non-target signal component based on the mask configuration, for example, the configuration of annular openings included in the mask. For instance, the system can select for removal sets of radiation counts arranged in an annular shape and having the greater intensity associated with the non-target radiation source.

At an operation 908, the system locates the target radiation source within the local region of the anatomical body using the filtered signal. The system can locate the target radiation source within the three-dimensional space of the local region of the anatomical body using techniques discussed herein; for example, the locating of the target radiation source can be also based also upon the mask configuration.

Alternative or in addition to the signal filtering of a non-target radiation source, the system can manipulate the radiation detection and/or imaging system to exclude the identified non-target radiation source from a limited FOV. For instance, the 3D CZT detector is configured to have a limited FOV to thereby focus upon the local region of the anatomical body. Thus, in some embodiments, the system locates the non-target radiation source within the three-dimensional space of the local region of the anatomical body and re-orients and/or re-positions the 3D CZT detector such that the non-target radiation source is excluded from the limited FOV of the detector (while the target radiation source remains within the limited FOV).

In some embodiments, the system provides an alert, visual indication, warning, or the like to a user that indicates that a non-target radiation source is detected within the FOV of the radiation detection and/or imaging system. This can suggest to the user that radiation count times make take longer time to process and resolve, and allows the user to adjust the camera until the non-target radiation source is no longer visible in the image.

### IV. Example Computing System

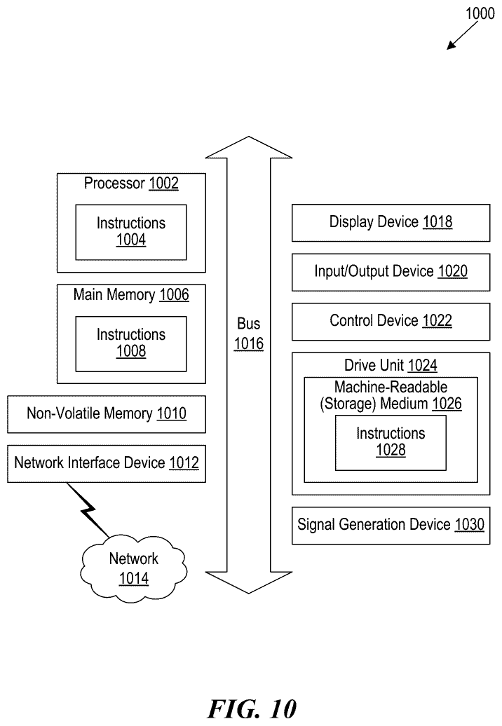

FIG. 10 is a block diagram that illustrates an example of a computer system 1000 in which at least some operations described herein can be implemented. For example, the computer system 1000 embodies at least a portion of the 3D CZT radiation detection system 100 and implements techniques disclosed herein to generating or reconstructing 3D radiation images. As shown, the computer system 1000 can include: one or more processors 1002, main memory 1006, non-volatile memory 1010, a network interface device 1012, video display device 1018, an input/output device 1020, a control device 1022 (e.g., keyboard and pointing device), a drive unit 1024 that includes a storage medium 1026, and a signal generation device 1030 that are communicatively connected to a bus 1016. The bus 1016 represents one or more physical buses and/or point-to-point connections that are connected by appropriate bridges, adapters, or controllers. Various common components (e.g., cache memory) are omitted from FIG. 10 for brevity. Instead, the computer system 1000 is intended to illustrate a hardware device on which components illustrated or described relative to the examples of the figures and any other components described in this specification can be implemented.

The computer system 1000 can take any suitable physical form. For example, the computing system 1000 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 1000. In some implementation, the computer system 1000 can be an embedded computer system, a system-on-chip (SOC), a single-board computer system (SBC) or a distributed system such as a mesh of computer systems or include one or more cloud components in one or more networks. Where appropriate, one or more computer systems 1000 can perform operations in real-time, near real-time, or in batch mode.

The network interface device 1012 enables the computing system 1000 to mediate data in a network 1014 with an entity that is external to the computing system 1000 through any communication protocol supported by the computing system 1000 and the external entity. Examples of the network interface device 1012 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 1006, non-volatile memory 1010, machine-readable medium 1026) can be local, remote, or distributed. Although shown as a single medium, the machine-readable medium 1026 can include multiple media (e.g., a centralized/distributed database and/or associated caches and servers) that store one or more sets of instructions 1028. The machine-readable (storage) medium 1026 can include any medium that is capable of storing, encoding, or carrying a set of instructions for execution by the computing system 1000. The machine-readable medium 1026 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 1010, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 1004, 1008, 1028) set at various times in various memory and storage devices in computing device(s). When read and executed by the processor 1002, the instruction(s) cause the computing system 1000 to perform operations to execute elements involving the various aspects of the disclosure.

### V. Example Technical Solutions

Some embodiments may implement one or more of the following solutions, listed in clause-format. The following clauses are supported and further described in the embodiments above and throughout this document. The following listing of solutions may be implemented by some preferred embodiments:

Solution 1. An apparatus for intraoperative radiation detection for an anatomical body, the apparatus comprising: a plurality of cadmium-zinc-telluride (CZT) crystals configured to generate charge in response to incident radiation emitted from a radiated area within a portion of the anatomical body; one or more electrodes distributed about the plurality of CZT crystals in three dimensions such that each respective electrode is associated with a respective three-dimensional portion of at least one of the plurality CZT crystals, each respective electrode configured to: collect the charge generated from the incident radiation at the respective three-dimensional portion of at least one of the plurality of CZT crystals; and induce electrical signals in response to the collected charge; a mask centered about the plurality of CZT crystals and positioned between the plurality of CZT crystals and the portion of the anatomical body, the mask comprising: radiation blocking material having openings exposing the plurality of CZT crystals, the openings defined by an annulus centered about the plurality of CZT crystals; and a processing subsystem configured to: measure the induced electrical signals; and generate a radiation image of the portion of the anatomical body based on the measurement of the induced electrical signals and a geometry of the openings.

Solution 2. An apparatus for intra-operative radiation detection for an anatomical body, the apparatus comprising: a radiation detector; a mask positioned between the radiation detector and a local region of the anatomical body; and a processing subsystem configured to generate a radiation image from signals induced by the radiation detector.

Solution 3. An apparatus for intraoperative localized radiation imaging for an anatomical body, the apparatus comprising: an imager comprising a plurality of cadmium-zinc-telluride (CZT) crystals configured for 3D-sensitive detection of incident radiation based on charge drift through each CZT crystal in response to the incident radiation emitted from radiation sources within the anatomical body; an aperture mask having a plurality of openings through a radiation blocking material, the plurality of openings being located throughout the aperture mask in an arrangement configured to align with the plurality of CZT crystals, wherein each of the plurality of openings is configured to project a radiation emission distribution of the incident radiation emitted from the radiation sources onto one or more of the plurality of CZT crystals; a processing subsystem comprising at least one processor and at least one memory storing instructions that, when executed by the at least one processor, cause the processing subsystem to perform operations comprising: reconstruct a radiation image based on the charges generated by the plurality of CZT crystals in response to the radiation emission distribution being projected by each of the plurality of openings onto the plurality of CZT crystals.

Solution 4. The apparatus of any one or more of the solutions disclosed herein, wherein the processing subsystem is further configured to: measure first induced electrical signals resulting from a first charge generated in response to a first detection, at a first location within the plurality of CZT crystals, of a gamma ray emitted from a first region within the portion of the anatomical body; measure second induced electrical signals resulting from a second charge generated in response to a second detection, at a second location within the plurality of CZT crystals, of the gamma ray, the second location different from the first location; determine the first location based on the measurement of the first induced electrical signal; determine the second location based on the measurement of the second induced electrical signal; extrapolate a third location of the first region within the portion of the anatomical body based on the first location, the second location, and the geometry of the openings; and in response to extrapolation of the third location, indicate, within the radiation image, that radiation is present at the third location.

Solution 5. The apparatus of any one or more of the solutions disclosed herein, wherein: the mask comprises: a first side adjacent the plurality of CZT crystals; and a second side opposite the first side and adjacent the portion of the anatomical body; and the openings: extend between the first side and the second side; are tapered from the first side toward an internal line between the first side and the second side; and are tapered from the second side toward the internal line.

Solution 6. The apparatus of any one or more of the solutions disclosed herein, wherein: the openings are tapered from the first side toward the internal line by one or more first taper angles; and the openings are tapered from the second side toward the internal line by one or more second taper angles different from the one or more first taper angles.

Solution 7. The apparatus of any one or more of the solutions disclosed herein, wherein: the openings comprise: interior edges closest to a center of the mask; and exterior edges closest to a periphery of the mask; the interior edges are tapered from the first side toward an internal line by a first taper angle; and the exterior edges are tapered from the first side toward an internal line by a second taper angle different from the first taper angle.

Solution 8. The apparatus of any one or more of the solutions disclosed herein, wherein the internal line is equidistant from the first side and the second side.

Solution 9. The apparatus of any one or more of the solutions disclosed herein, wherein the plurality of CZT crystals have a thickness greater than 10 millimeters (mm).

Solution 10. The apparatus of any one or more of the solutions disclosed herein, wherein the processing subsystem is configured to: collect a signal from the radiation detector, the signal capturing radiation intensity within the local region of the anatomical body; identify, within the signal, a non-target radiation source having a signal intensity that is a threshold greater than a target radiation source located within the local region of the anatomical body; filter the signal to remove a signal component associated with the non-target radiation source, the filtering being based on a configuration of the mask; and locate the target radiation source within the local region of the anatomical body using the filtered signal.

Solution 11. The apparatus of any one or more of the solutions disclosed herein, wherein the plurality of CZT crystals is four crystals arranged in a 2×2 array.

Solution 12. The apparatus of any one or more of the solutions disclosed herein, wherein the plurality of CZT crystals are arranged such that respective front surfaces of the plurality of CZT crystals are aligned.

Solution 13. The apparatus of any one or more of the solutions disclosed herein, wherein the plurality of CZT crystals are all positioned within a single casing to which the aperture mask is attached.

Solution 14. The apparatus of any one or more of the solutions disclosed herein, wherein front surfaces of the plurality of CZT crystals are aligned to be parallel to a front end of the imager.

Solution 15. The apparatus of any one or more of the solutions disclosed herein, wherein each of the plurality of CZT crystals has a thickness depth that is greater than 10 millimeters.

Solution 16. The apparatus of any one or more of the solutions disclosed herein, wherein the plurality of openings are arc-shaped and are arranged to define an annulus centered about a center point between the plurality of CZT crystals.

Solution 17. The apparatus of any one or more of the solutions disclosed herein, wherein the plurality of openings are pinholes.

Solution 18. The apparatus of any one or more of the solutions disclosed herein, wherein the plurality of openings are tapered through a thickness of the aperture mask.

Solution 19. The apparatus of any one or more of the solutions disclosed herein, wherein a taper angle of the plurality of openings on one side of a center line through the thickness of the aperture mask is different from another taper angle of the plurality of openings on an opposite side of the center line.

Solution 20. The apparatus of any one or more of the solutions disclosed herein, wherein the radiation blocking material includes tungsten.

Solution 21. The apparatus of any one or more of the solutions disclosed herein, wherein the operations further comprise performing a filtering to remove a non-target radiation source from the radiation image.

Solution 22. A computer-implemented method comprising: collecting a signal from a 3D-sensitive radiation detector having a mask with an annular opening configuration, the signal capturing radiation intensity within a local region of the anatomical body; identifying, within the signal, a non-target radiation source having an intensity that is a threshold greater than a target radiation source located within the local region of the anatomical body; filtering the signal to remove a signal component associated with the non-target radiation source based on the annular opening configuration; and generating a radiation image of the local region of the anatomical body from the filtered signal, the radiation image capturing the target radiation source and excluding the non-target radiation source.

Solution 23. The method of any one or more of the solutions disclosed herein, wherein the target radiation source is a physiological feature within the local region of the anatomical body, and wherein the threshold is based on a radiotracer uptake rate associated with the physiological feature.

Solution 24. The method of any one or more of the solutions disclosed herein, further comprising: locating the non-target radiation source within the local region of the anatomical body; and adjusting, or indicating to a user to adjust, at least one of a position or an orientation of the 3D-sensitive radiation detector for a new local region that excludes the non-target radiation source.

Solution 25. The method of any one or more of the solutions disclosed herein, wherein the signal captures the radiation intensity for an initial time period after an injection of a radiotracer into the anatomical body, wherein the initial time period is based on a lymphatic drain rate.

Solution 26. The method of any one or more of the solutions disclosed herein, wherein the target radiation source is a sentinel lymph node, and wherein the non-target radiation source is a radiotracer injection site.

Solution 27. A method for localized radiation imaging, comprising: providing an apparatus of any one or more of the solutions disclosed herein; positioning the apparatus within a short range of a target imaging region; and obtaining a 3D radiation image from the apparatus in real-time.

Solution 28. The method of any one or more of the solutions disclosed herein, wherein the apparatus is positioned near the target imaging region at a distance that is less than 20 centimeters.

### VI. Remarks

Although described with respect to particular embodiments, the functions described herein may be implemented in hardware, software executed by a processor, firmware, or any combination thereof. Other examples and implementations are within the scope of the disclosure and appended claims. Features implementing functions may also be physically located at various positions, including being distributed such that portions of functions are implemented at different physical locations.

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

From the foregoing, it will be appreciated that specific embodiments of the invention have been described herein for purposes of illustration but that various modifications may be made without deviating from the scope of the invention. Rather, in the foregoing description, numerous specific details are discussed to provide a thorough and enabling description for embodiments of the present technology. One skilled in the relevant art, however, will recognize that the disclosure can be practiced without one or more of the specific details. In other instances, well-known structures or operations often associated with memory systems and devices are not shown, or are not described in detail, to avoid obscuring other aspects of the technology. In general, it should be understood that various other devices, systems, and methods, in addition to those specific embodiments disclosed herein, may be within the scope of the present technology.

What is claimed is:

1. A system for intraoperative localized radiation imaging for an anatomical body, the system comprising:
a mobile imager device comprising therewithin a plurality of cadmium-zinc-telluride (CZT) crystals each configured for 3D-sensitive detection of incident radiation based on charge drift through each CZT crystal in response to the incident radiation;
an aperture mask having a plurality of openings through a radiation blocking material, the plurality of openings being located throughout the aperture mask in an arrangement configured to align with the plurality of CZT crystals, wherein each of the plurality of openings is configured to project a radiation emission distribution from radiation sources located within an imaging region of the anatomical body onto one or more of the plurality of CZT crystals;
a processing subsystem comprising at least one processor and at least one memory storing instructions that, when executed by the at least one processor, cause the processing subsystem to perform operations comprising:
reconstruct a 3D radiation image based on the charges generated by the plurality of CZT crystals in response to the radiation emission distribution being projected by each of the plurality of openings onto the plurality of CZT crystals.

2. The system of claim 1, wherein the plurality of CZT crystals is four crystals arranged in a 2×2 array.

3. The system of claim 1, wherein the plurality of CZT crystals are arranged such that respective front surfaces of the plurality of CZT crystals are aligned.

4. The system of claim 1, wherein the plurality of CZT crystals are all positioned within a single casing to which the aperture mask is attached.

5. The system of claim 1, wherein each of the plurality of CZT crystals has a thickness depth that is greater than or equal to 10 millimeters.

6. The system of claim 1, wherein the plurality of openings are arc-shaped and are arranged to define an annulus centered about a center point between the plurality of CZT crystals.

7. The system of claim 1, wherein the plurality of openings are pinholes.

8. The system of claim 1, wherein the plurality of openings are tapered through a thickness of the aperture mask.

9. The system of claim 1, wherein a taper angle of the plurality of openings on one side of a center line through the thickness of the aperture mask is different from another taper angle of the plurality of openings on an opposite side of the center line.

10. The system of claim 1, wherein the radiation blocking material includes tungsten.

11. The system of claim 1, wherein the operations further comprise performing a filtering to remove a non-target radiation source from the radiation image.

12. The system of claim 11, wherein the imager further comprises one or more electrodes distributed about the plurality of CZT crystals such that each respective electrode is associated with a respective three-dimensional portion of at least one of the plurality of CZT crystals, each respective electrode being configured to: collect the charge generated from the incident radiation within the respective three-dimensional portion of at least one of the plurality of CZT crystals; and induce electrical signals that encode a three-dimensional depth position of the charge within the respective three-dimensional portion in response to the collected charge.

13. The system of claim 1, wherein the processing subsystem is further configured to:
measure first induced electrical signals resulting from a first charge generated in response to a first detection, at a first location within the plurality of CZT crystals, of a gamma ray emitted from a first region within the portion of the anatomical body;
measure second induced electrical signals resulting from a second charge generated in response to a second detection, at a second location within the plurality of CZT crystals, of the gamma ray, the second location different from the first location;
determine the first location based on the measurement of the first induced electrical signal;
determine the second location based on the measurement of the second induced electrical signal;
extrapolate a third location of the first region within the portion of the anatomical body based on the first location, the second location, and the geometry of the openings; and
in response to extrapolation of the third location, indicate, within the radiation image, that radiation is present at the third location.

14. The system of claim 1, wherein:
the aperture mask comprises:
a first side adjacent the plurality of CZT crystals; and
a second side opposite the first side and adjacent the portion of the anatomical body; and
the openings:
extend between the first side and the second side;
are tapered from the first side toward an internal line between the first side and the second side; and
are tapered from the second side toward the internal line.

15. The system of claim 14, wherein:
the openings are tapered from the first side toward the internal line by one or more first taper angles; and
the openings are tapered from the second side toward the internal line by one or more second taper angles different from the one or more first taper angles.

16. The system of claim 14, wherein:
the openings comprise:
interior edges closest to a center of the mask; and
exterior edges closest to a periphery of the mask;
the interior edges are tapered from the first side toward an internal line by a first taper angle; and
the exterior edges are tapered from the first side toward an internal line by a second taper angle different from the first taper angle.

17. The system of claim 12, wherein the internal line is equidistant from the first side and the second side.

18. A method for intraoperative localized radiation imaging, comprising:
providing a 3D radiation imaging system that comprises (i) a mobile imager device comprising therewithin a plurality of cadmium-zinc-telluride (CZT) crystals each configured for 3D-sensitive detection of incident radiation, and (ii) an aperture mask having a plurality of openings through a radiation blocking material, the plurality of openings being located throughout the aperture mask in an arrangement configured to align with the plurality of CZT crystals, wherein each of the plurality of openings is configured to project a radiation emission distribution from radiation sources located within an imaging region of the anatomical body onto one or more of the plurality of CZT crystals;
positioning the 3D radiation imaging system such that the plurality of CZT crystals are disposed at a distance away from the imaging region, wherein the distance is less than 20 centimeters; and
obtaining a 3D radiation image based on reconstructing signals corresponding to the charges generated by the plurality of CZT crystals in response to the radiation emission distribution being projected by each of the plurality of openings onto the plurality of CZT crystals.

19. The method of claim 18, wherein the 3D radiation image is obtained in real-time or near real-time.

20. The method of claim 18, wherein each of the plurality of CZT crystals has a thickness depth that is greater than or equal to 10 millimeters.
